(19) United States
(12) Patent Application Publication
(10) Pub. No.: US 2013/0036749 A1
(43) Pub. Date: Feb. 14, 2013

(54) Fuel Cell System and Method for Operating a Fuel Cell System

(71) Applicants: Meenakshi Sundaresan, Kirchheim/Teck (DE); Steffen Dehn, Nersingen (DE)

(72) Inventors: Meenakshi Sundaresan, Kirchheim/Teck (DE); Steffen Dehn, Nersingen (DE)

(73) Assignee: DAIMLER AG, Stuttgart (DE)

(21) Appl. No.: 13/635,000

(22) PCT Filed: Dec. 8, 2010
(86) PCT No.: PCT/EP2010/007453

§ 371 Date: Oct. 16, 2012

(30) Foreign Application Priority Data
Mar. 16, 2010 (DE) 10 2010 011 559.2

(51) Int. Cl. F02C 6/00; H01M 8/00

(52) U.S. Cl. 60/783; 60/39.12

(57) ABSTRACT

A fuel cell system includes at least one fuel cell with an anode region and a cathode region, a burner for burning exhaust gases from the fuel cell and also additional fuel that may optionally be supplied, and a storage volume for intermediate storage of exhaust gases that flow away continuously or discontinuously via a valve from the anode region of the fuel cell, the storage volume being arranged between the anode region and the burner. The hot exhaust gases of the burner are expanded in an expansion device. A method of the operation of a fuel cell system involves controlling an additional valve after the storage volume.

### BACKGROUND AND SUMMARY OF THE INVENTION

The invention relates to a fuel cell system and a method for operating a fuel cell system.

It is known to use fuel cell systems to generate electrical energy. The following discussion relates to a fuel cell system with a stack of individual fuel cells that are formed, for example, as PEM fuel cells. These concepts, however, are in principle equally applicable to other fuel cell types. The fuel cell or the fuel cell stack typically always has a cathode region that is provided with oxygen, for example supplied air. Further, the fuel cell has an anode region that is supplied with a fuel, typically a hydrogen-containing gas or hydrogen, in gaseous form.

For the anode region, in some cases the fuel flows through it, so that an excess amount of fuel comes from the anode region as exhaust gas. Depending on the embodiment, the construction in this case can be selected such that only a minimal amount of fuel emerges from the anode region, while the major part of the fuel is used up in the anode region. This is commonly referred to as a “near-dead-end stack”. The alternative to this would be a fuel cell without an outlet in the anode region, what is called a “dead-end stack”, in which all the fuel supplied is used up. As a further very widely used alternative in constructing an anode region, provision may furthermore be made to load the anode region with a great excess of fuel. Then a comparatively large amount of fuel will flow out of the anode region as exhaust gas. In order not to waste this fuel, it is then recirculated, in what is called an “anode loop”, back to the inlet of the anode region and is mixed there with the fresh fuel flowing to the anode region.

Over time nitrogen becomes enriched in the anode region, diffusing through the membranes of the fuel cells from the cathode region or the air located in the cathode region into the anode region. Furthermore, part of the product water that is produced upon generating current with the fuel cell forms in the anode region. In the typically preferred structural forms of an anode region either with an anode loop or in the manner of a near-dead-end stack, these undesirable substances can be removed from the anode region with the exhaust gas, or in the case of an anode loop are typically removed from time to time via a discharge valve. All these exhaust gases, irrespective of whether they are from an anode loop or from the anode region directly, always have in such case a remnant of the fuel or hydrogen, in addition to water and inert gases. It is therefore known from the prior art to afterburn these substances by means of a burner or the like, in order to avoid emissions of fuel to the environment.

In this connection, German Patent Document DE 11 2004 001 483 B4 discloses temporarily storing exhaust gas from the anode region of the fuel cell in a chamber or a storage volume in order to then—for example continuously—be supplied to a burner.

A similar construction is also known from U.S. Patent Application Publication No. US 2005/0214617 A1. Here, likewise a collecting vessel or storage volume for the exhaust gas from the anode region is used. The emission to the environment in this case also takes place continuously and comparatively slowly, so that corresponding mixing with the exhaust gas from the cathode region ensures an overall exhaust gas that at all times lies below a critical fuel/oxygen mixture and thus can be released unburned to the environment.

German Patent Document DE 103 06 234 B4 discloses afterburning the exhaust gases of a fuel cell in a burner. The afterburned exhaust gases or the hot exhaust gas of this afterburning can then be utilized in an expansion device, for example a turbine. The aforementioned patent specification describes the construction of a turbocharger, in which this turbine drives a compressor for the incoming air to the cathode region. Furthermore, an electric machine can be provided that, if required, provides additional drive power for the compressor, and which in the event of an excess of energy at the turbine can also be operated as a generator. The electrical energy thus generated can then be stored or otherwise used. This construction is also referred to as an electric turbocharger or ETC.

In this connection, German Patent Document DE 103 25 452 A1 furthermore describes the possibility of a “boost” operation, in which additional fuel is supplied for the burner, which then, if necessary, provides additional energy to the expansion device and thus either can improve the air supply to the cathode region or generates electrical energy directly via the electric machine. When used in a vehicle, this boost operation may, for example, be used to provide a large amount of electrical energy briefly and very quickly in the case of an acceleration demand of the vehicle, until the fuel cell, which is comparatively slow in terms of its dynamics, implements the demand accordingly and satisfies the energy requirement completely itself. Therefore the dynamics of the generation of electric power by the fuel cell system can be improved by means of such a boost operation.

Exemplary embodiments of the present invention are directed to a fuel cell system that optimizes utilization of energy and dynamics in the fuel cell system, and which satisfies the performance requirements made on the fuel cell system with minimal installation space and efficient utilization of the energy used.

In accordance with exemplary embodiments of the present invention a fuel cell system is provided in which the exhaust gases from the region of the anode are temporarily stored in a storage volume before passing from there into the region of a burner. In the burner, they are then reacted accordingly and the hot exhaust gases of the burner drive an expansion device in which the hot exhaust gases are expanded. Thus, with the expansion device the energy content in the exhaust gases from the region of the anode can be utilized by combustion, for example together with the exhaust gases from the cathode, which contain residual oxygen. The energy balance of such a system will therefore be better than in a system in which the exhaust gases are merely burned in order to prevent fuel emissions from escaping. Furthermore, the use of a storage volume permits very efficient controlling and very efficient operation of the expansion device or the burner, since cathode exhaust gas can be collected and supplied specifically to the burner, in particular if there is a corresponding energy requirement.

In accordance with the present invention the expansion device is a turbine in a turbocharger. If a valve for controlling or regulating the volumetric flow emerging from the storage volume is also provided, in accordance with a very beneficial development of the fuel cell system according to the invention, then the combustion of the exhaust gases from the anode region can always take place very specifically by means of the turbine as expansion device when the energy is already required for conveying incoming air to the cathode.

The method according to the invention for operating a fuel cell system in this case provides a valve after the storage volume. The flow of the anode exhaust gas out of the storage volume can thus be influenced. Particularly preferably, it may be set dependent on the degree of filling in the storage volume. Thus, for example, corresponding collection of the discontinuously outflowing exhaust gas in the storage volume can take place from a discontinuous outflow of the exhaust gas out of the anode region, which is particularly advantageous for removing water collected in the anode region. From there, it can then be supplied continuously, or in the case of an appropriate energy requirement continuously over a certain period, to the burner, in order thus to be able to provide the required output in the region of the expansion device.

### BRIEF DESCRIPTION OF THE DRAWING FIGURES

Further advantageous configurations of the device according to the invention and of the method according to the invention will become apparent from the rest of the dependent claims, and will become clear with reference to the example of embodiment. This will be described in greater detail below with reference to the figures.

Therein:

FIG. 1 is a diagrammatic representation of an exemplary construction of a fuel cell system according to the invention; and

FIG. 2 is a flow diagram for operating the fuel cell system illustrated in FIG. 1.

### DETAILED DESCRIPTION

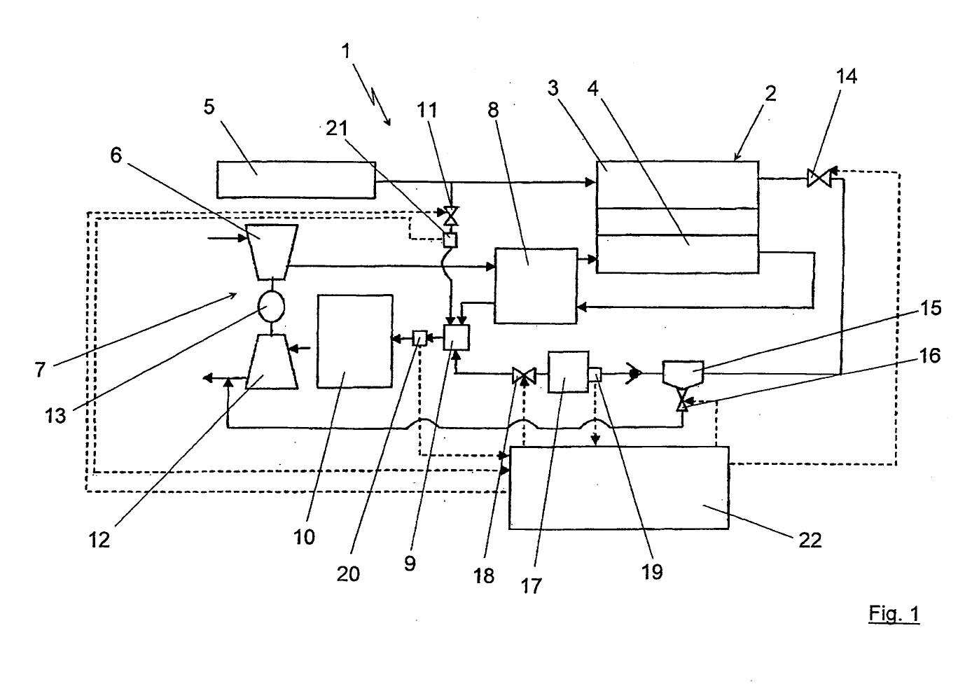

FIG. 1 illustrates, by way of example, a fuel cell system 1. This basically consists of a fuel cell 2, which is intended by way of example to be constructed as a stack of PEM fuel cells. This stack 2 of individual fuel cells has an anode region 3 and a cathode region 4. The anode region 3 is supplied with hydrogen from a hydrogen storage means 5, the pressure reducer, valves and the like having been omitted in the representation of FIG. 1 here. Despite this, they are present in the manner known per se. The cathode region 4 of the fuel cell 2 is supplied with air via a compressor 6, which is formed here as part of an electric turbocharger 7 (ETC) which is described in greater detail later. The compressor 6 in the construction illustrated here is preferably designed as a flow compressor, but alternative configurations and modes of construction of the compressor 6 would likewise be conceivable. The air drawn in via the compressor 6 then flows to a charge-air cooler 8 and then into the cathode region 4 of the fuel cell 2. In the fuel cell 2, the hydrogen in the anode region is reacted with the oxygen of the air located in the cathode region 4 in a manner known per se, with water and electric power being produced. Then an exhaust gas, which is substantially an exhaust air depleted in oxygen together with a certain content of water and water vapor, flows out of the cathode region 4. This comparatively cool exhaust air then again flows through the charge-air cooler 8 and there cools the incoming air which is heated up after the compressor 6 on its way to the cathode region 4. After the charge-air cooler 8, the air flows into a mixer 9 and then into a burner 10, which is designed, for example, as a porous burner, but in particular as a catalytic burner.

In order to produce a combustible mixture in the mixer 9, an exhaust gas from the anode region 3 of the fuel cell flows to the mixer 9 in a manner to be described in greater detail later. If required, optional hydrogen can be passed to the mixer 9 via a valve 11, so that a mixture that can be burned in the burner 10 is produced in the mixer 9 in each case. The hot exhaust gases of the burner 10 then flow into an expansion device 12, which here again is formed as part of the electric turbocharger 7. The expansion device 12 is typically formed as a turbine arranged on a common shaft with the compressor 6. In the configuration as an electric turbocharger 7 used here, furthermore an electric machine 13 is arranged on the common shaft.

Essentially, in this case three different operating modes of the electric turbocharger 7 can be distinguished. Either the expansion device 12 can provide all the energy required for the compressor 6, then the electric machine 13 will merely run empty along with it. In the event of an excess of energy in the region of the expansion device 12, the electric machine 13 can be operated as a generator. Then electrical energy can additionally be produced via the expansion device 12 and the electric machine 13, which energy is available alternatively or in addition to the electrical energy from the fuel cell 2. Thus, for example, when a vehicle is equipped with the fuel cell system 1 an abrupt increase in the performance requirement can be met within a very short time. Then, if required, optional fuel for the burner 10 is made available via the valve 11, so that the electrical energy is available at the electric machine 13 by means of a boost or turbo-boost. In the latter application, in which the expansion device 12 cannot provide all the energy required for the compressor 6, the electric machine 13 can also be motor-driven, in order thus to compensate for the required energy difference.

In the preferred construction of the invention, the anode region 3 is now intended to be designed as what is called a “near-dead-end” anode region 3. This means that hydrogen flows through the anode region 3 and that the region is configured such that merely a very small proportion of hydrogen and also optionally nitrogen that has diffused through the membranes and a certain amount of product water are produced as exhaust gas. Such near-dead-end anode regions are typically constructed as cascaded anode regions 3, i.e., such that the available active surface of the anode region 3 decreases from section to section in the direction of flow of the hydrogen, in particular at a similar rate to that at which the hydrogen in the anode region 3 is used up. This ensures that approximately the same amount or concentration of hydrogen per active unit of surface area over which the hydrogen flows is available. Such constructions make it possible to dispense with a costly anode loop, which is typically operated via a conveying means, for example a hydrogen recirculation blower or the like, in order to carry non-consumed hydrogen back to the anode inlet.

A near-dead-end anode region 3 may, for example, in a cascaded configuration manage with a hydrogen excess of a few percent. This gas is discharged from the fuel cell 2. This can be done with a continuous flow, for example through an orifice or the like. It can, however, also be done using a valve 14, what is called a purge valve, the purge valve 14 being operated in clocked manner, so that the exhaust gas from the anode region 3 is released discontinuously or intermittently. This generally permits better discharge of the product water produced in the anode region 3, since there is then always a greater pressure difference for blowing off this product water than there is with continuous flowing of the exhaust gases out of the anode region 3. The anode exhaust gases, after the valve 14, then pass, by way of example, into a water separator 15, which is formed as a simple water trap. From the water separator 15, the water passes via a valve 16 and a corresponding line element into the region of the exhaust air after the expansion device 12. The exhaust gas that has been freed from liquid water passes via a non-return valve into a storage volume 17 and then via a valve 18 to the mixer 9, in order to be mixed, together with the exhaust gas from the cathode region 4 and possibly hydrogen optionally supplied from the hydrogen storage means 5 via the valve 11, and supplied to the burner 10.

These streams of substances are represented in the illustration of FIG. 1 in this case as solid lines.

In the illustration of FIG. 1, various sensors are also illustrated. A pressure sensor 19 is arranged in the region of the storage volume 17. Furthermore, there is a hydrogen concentration sensor 20 in the region of the flow between the mixer 9 and the burner 10. A flow sensor 21 for hydrogen is located in the line element that connects the valve 11 to the mixer 9. The sensors supply their values, as represented by the broken lines, to control electronics 22. From these control electronics 22, then the valve 11, 14, 16 and 18 present in the fuel cell system 1 are correspondingly controlled or the throughflows through these valve 11, 14, 16 and 18 are regulated.

The construction according to the invention therefore provides a storage volume 17 together with the burner 10, the hot exhaust gases of which are additionally used for generating energy in an expansion device 12. This construction permits very efficient operation of the burner 10, because the hydrogen from the storage volume 17 can be supplied thereto continuously or continuously as required. Furthermore, the storage volume 17 permits discontinuous discharge of the anode exhaust gases via the valve 14. This is to be preferred due to the greater pressure difference compared with discharging via a fixed orifice, which is also conceivable, since more water is discharged from the anode region 3 due to the greater pressure difference. This improves the system performance of the fuel cell 2. The construction with the storage volume 17 may in this case be controlled via the pressure sensor 19 and the valve 18 such that the flow of the exhaust gas away out of the storage volume 17 can be changed, for example, depending on the pressure and hence dependent on the degree of filling of the storage volume 17. Furthermore, in the case of discontinuous discharge of exhaust gas from the anode region 3, the frequency of this intermittent discharge via the valve 14 can be stored in the control electronics 22. Depending on the load status of the fuel cell 2, a suitable strategy for discharging the exhaust gas from the anode region 3 can be selected. At the same time, the amount of exhaust gas that flows into the region of the storage volume 17 can be detected by means of the frequency and the amount of exhaust gases produced, which corresponds to the load point. In this manner, without a pressure sensor 19 being absolutely necessary, the degree of filling of the storage volume can also be determined and thus the onward guidance of the gas flowing out of the storage volume can be set using the degree of filling.

In a boost operation, i.e., if additional hydrogen is conveyed to the mixer 9 and hence to the burner 10 via the valve 11, because additional energy is necessary in the region of the expansion device 12, this construction with the storage volume 17 can provide particular advantages. The hydrogen concentration of the gas flowing to the burner 10 can be determined by means of the hydrogen sensor 20. Thus, a temperature that is to be expected upon the combustion in the burner 10 can be predicted by the control electronics 22. If this calculation shows that a permissible maximum temperature risks being exceeded, the throughflow of hydrogen detected by the flow sensor 21 can be restricted or regulated to a lower throughflow by means of the valve 11. Thus, it can be ensured that the temperature to be expected in the burner 10 does not exceed the permissible maximum temperature. Nevertheless, due to the additional hydrogen and the hydrogen temporarily stored in the storage volume 17, the demand with regard to the output on the boost operation can be met up to a system-dependent upper limit. This is possible for a comparatively low requirement of additional hydrogen from the hydrogen storage means 5, and hence in a very energy efficient manner.

The size of the storage volume 17 is of decisive significance for the functionality. It may be perfectly appropriate to select the storage volume to be comparatively large. In particular, when the fuel cell system 1 is used in a motor vehicle the size, however, has to be minimized due to installation space restrictions and the desire to have a low weight of the fuel cell system 1. If one takes a fuel cell 2 in a fuel cell system 1 typically used for motor vehicles, for example a PEM fuel cell with an output of the order of 50 to 90 kW, exhaust gas volumes from the anode region 3, if this is operated as a near-dead-end stack, which are of the order of from 0.2 to approximately 10 liters, are yielded per second, depending on the loading case of the fuel cell 2. Now, in particular for operation at low load, intermediate storage of the anode exhaust gas 3 for several seconds should be possible. At full load, also comparatively large amounts of water, which have to be discharged in order to maintain the functionality of the anode region 3, are produced in addition to the anode exhaust gas 3. With this configuration, the intermediate storage of the anode exhaust gas 3 therefore has to take place only for a rather short period. If a period of several seconds, for example 4 to 8 seconds, is estimated for the low load and a period of less than 1 second for the full load, then an optimized storage volume of the order of from 1 to 3 liters, in particular of the order of approximately 2 liters, is yielded for the system mentioned above. The construction can therefore be optimized with regard to the functionality and the installation space with a storage volume 17 having a storage capacity of approximately 2 liters.

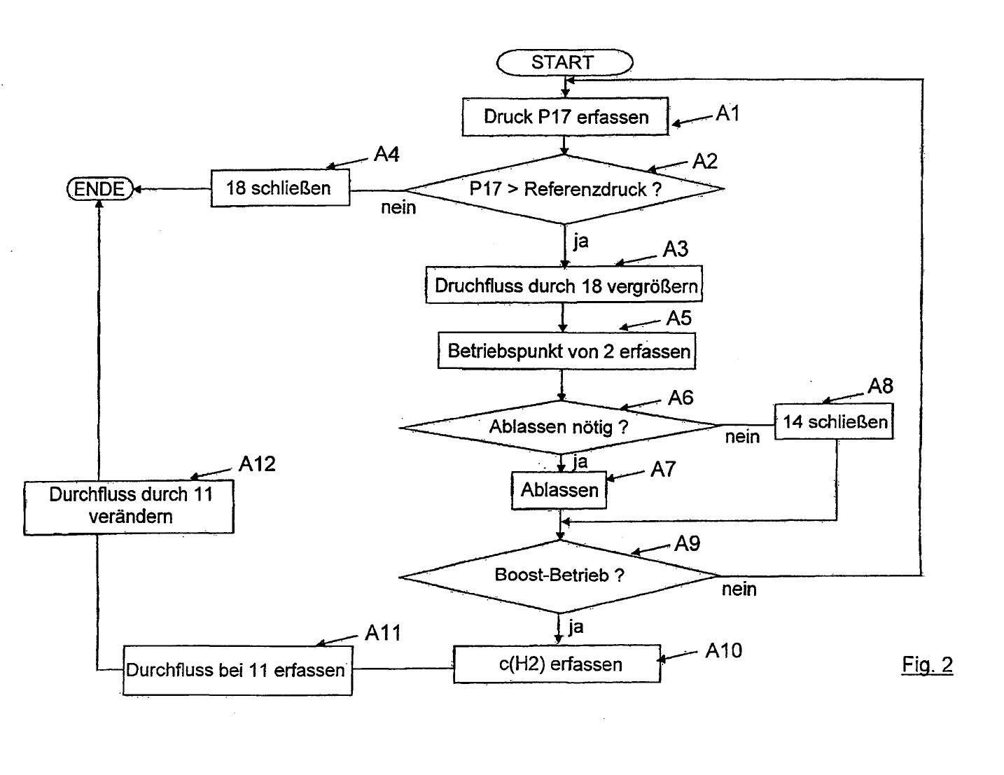

Below, with reference to a flowchart, an exemplified operation for the fuel cell system 1 illustrated in FIG. 1 is now illustrated in FIG. 2, and will be explained in greater detail below.

In FIG. 2, the control sequence described, which will typically be carried out in the control electronics 22, starts in the oval box marked “Start”. In step A1, the pressure in the storage volume 17 is detected. In the second method step A2, this pressure, which will be designated P17 below, is compared with a pre-set reference pressure. The reference pressure in this case typically indicates the pressure value for the full storage volume 17. As soon as the pressure P17 reaches or exceeds this reference pressure, the storage volume 17 is therefore filled. If the pressure P17 detected in the storage volume 17 lies above the pre-set reference pressure, step A3 is triggered, in which the throughflow through the valve 18 is increased, the storage volume 17 therefore empties or the degree of filling increases less quickly. If the pressure P17 in the storage volume 17 becomes less than the pre-set reference pressure, the selection switches to method step A4 and the valve 18 of the storage volume 17 is closed. After step A4, the process is terminated and can be started again directly or after a short waiting time.

In the following method step A5, the operating point of the fuel cell is then detected. It can then be established in step A6 using the operating point of the fuel cell whether it is necessary to let off anode exhaust gas. If this is not the case, the valve 14 is closed in step A8. If it is necessary to let exhaust gas off, after step A6, step A7 is triggered in which exhaust gas is let off into the storage volume 17 from the anode region 3 via the valve 14. In the following step A9, it is then analyzed whether the fuel cell system 1 is momentarily in boost operation. If this is not the case, a switch is made back to the start or to method step A1. If, on the other hand, the fuel cell system 1 is momentarily in boost operation, a switch onward to method step A10 is made and the concentration of the hydrogen flowing to the burner is detected with the hydrogen sensor 20. In method step A11, then volumetric hydrogen flow through the valve 11 to the mixer 9 is calculated or detected, and is correspondingly influenced, typically choked, in method step A12. Then the sequence ends in the oval box marked “End”. The method can then be started again directly or after a short waiting time.

With the described construction and the described method, the fuel efficiency of the fuel cell system 1 can be increased by a storage volume 17 for intermediate storage of the exhaust gas from the anode region 3 and an expansion device 12 after the burner 10, in particular if it is an anode region 3 in a near-dead-end embodiment. The afterburning and the utilization of the hot exhaust gases in the expansion device 12 means that energy can therefore be saved and the efficiency of the entire system can be increased.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A fuel cell system, comprising:
a fuel cell having an anode region and a cathode region;
a burner configured to burn exhaust gases from the fuel cell and also additional fuel that may optionally be supplied;
a storage volume configured for intermediate storage of exhaust gases flowing away continuously or discontinuously via a valve from the anode region of the fuel cell, wherein the storage volume is between the anode region and the burner; and
an expansion device arranged after the burner in a direction of flow of a hot exhaust gases of the burner.

12. The fuel cell system as claimed in claim 11, wherein the expansion device is a turbine in an electric turbocharger.

13. The fuel cell system as claimed in claim 11, wherein the fuel cell has an open anode configuration with an active surface that decreases in cascading manner in the direction of flow.

14. The fuel cell system as claimed in claim 1, wherein the valve is configured to control or regulate a volumetric flow emerging from the storage volume and the valve is arranged after the storage volume in the direction of flow.

15. A method for operating a fuel cell system comprising a fuel cell having an anode region and a cathode region, a burner configured to burn exhaust gases from the fuel cell and also additional fuel that may optionally be supplied, a storage volume configured for intermediate storage of exhaust gases flowing away continuously or discontinuously via a valve from the anode region of the fuel cell, wherein the storage volume is between the anode region and the burner, and an expansion device arranged after the burner in a direction of flow of a hot exhaust gases of the burner, wherein the valve is arranged after the storage volume in the direction of flow, the method comprising:
controlling or regulating a volumetric flow emerging from the storage volume;
setting a flow of the anode exhaust gas out of the storage volume dependent on a degree of filling of the storage volume.

16. The method as claimed in claim 15, wherein the flow of the anode exhaust gas out of the storage volume is set dependent on a pressure in the storage volume.

17. The method as claimed in claim 15, wherein flowing of the exhaust gas out of the anode region takes place intermittently, with the flow of the anode exhaust gas out of the storage volume being set dependent on whether or not exhaust gas is currently being released from the anode region.

18. The method as claimed in claim 15, wherein the flow of the anode exhaust gas out of the storage volume is set dependent on a detected or calculated temperature of the exhaust gases of the burner.

19. The method as claimed in claim 15, wherein when an additional energy requirement optional fuel is supplied at the expansion device, an amount of optional fuel is set depending on detected or predicted temperature in a region of the burner and depending on the exhaust gas available from the storage volume.

20. The method as claimed in claim 19, wherein an amount of fuel flowing to the burner is monitored with a fuel concentration sensor arranged before the burner in the direction of flow before the burner.
